(19) United States
(12) Patent Application Publication
(10) Pub. No.: US 2003/0154577 A1
(43) Pub. Date: Aug. 21, 2003

(54) Binding nail device having protective cap

(76) Inventor: Jien Wei Huang, Chang Hua (TW)

Correspondence Address: Jien Wei Huang, 7F, No. 46, Pin Ho 10 Street, Chang Hua, 500, TW

(21) Appl. No.: 10/073,114

(22) Filed: Feb. 12, 2002

(51) Int. Cl. B42F 1/00

(52) U.S. Cl. 24/67 R

(57) ABSTRACT

A binding nail device includes a head having an upward extended peripheral fence, and two legs each having a bent portion secured to the peripheral flange of the head and bent toward each other for allowing the legs to be contacted with each other. A cap includes an outer peripheral portion having an upward extended peripheral wall for forming a chamber and for receiving the head. The peripheral wall includes an upper peripheral flange folded to engage with and to secure onto the peripheral flange of the head and for protecting the cap from being rusted.

### BACKGROUND OF THE INVENTION

1. Field of the Invention

The present invention relates to a binding nail device, and more particularly to a binding nail device having a protective cap for protecting the head of the binding nail device.

2. Description of the Prior Art

As shown in FIG. 1, a typical binding nail device includes a head 10 having a peripheral wall 11 extended upward from the outer peripheral portion thereof, and two legs 12 each having an enlarged root portion or bent portion 14 formed or provided in the bottom portion thereof and extended from or coupled to the upper portion of the peripheral wall 11 of the head 10. The head 10 and the legs 32 are made of metal materials and have not been shielded or protected, and thus may be easily rusted after use. In addition, the metal head 10 may not be applied with various kinds of colors or patterns thereon.

The present invention has arisen to mitigate and/or obviate the afore-described disadvantages of the conventional binding nail devices.

### SUMMARY OF THE INVENTION

The primary objective of the present invention is to provide a binding nail device including a protective cap for protecting the head of the binding nail device.

In accordance with one aspect of the invention, there is provided a binding nail device comprising a head having an upward extended peripheral fence, and two legs each having a bent portion secured to the peripheral flange of the head and bent toward each other for allowing the legs to be contacted with each other. A cap includes an outer peripheral portion having an upward extended peripheral wall for forming a chamber and for receiving the head. The peripheral wall includes an upper peripheral flange folded to engage with and to secure onto the peripheral flange of the head and for protecting the cap from being rusted. The cap may be applied with various kinds of colors or patterns for decorative purposes.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view illustrating a typical binding nail device;

FIG. 2 is a perspective view of a binding nail device in accordance with the present invention;

FIG. 3 is an exploded view of the binding nail device;

FIG. 4 is a cross sectional view taken along lines 4-4 of FIG. 2; and

FIG. 5 is a cross sectional view similar to FIG. 4, illustrating the operation of the binding nail device.

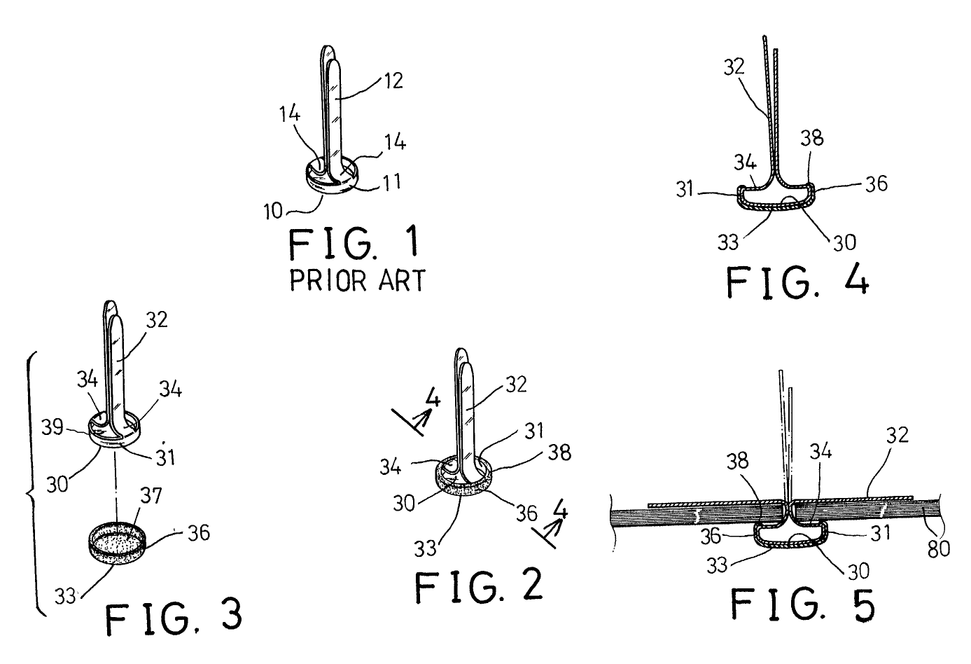

### DETAILED DESCRIPTION OF THE PREFERRED EMBODIMENT

Referring to the drawings, and initially to FIGS. 2-4, a binding nail device in accordance with the present invention comprises a disc-shaped head 30 including a peripheral fence 31 extended upward from the outer peripheral portion thereof for forming a space 39 therein, and two nails or legs 32 each having an enlarged root portion or bent portion 34 formed or provided in the bottom portion thereof and extended from or coupled to the upper portion of the peripheral fence 31 of the head 30. The bent portions 34 of the legs 32 are bent toward each other for allowing the legs 32 to be contacted with each other.

The binding nail device further includes a cap 33 having a peripheral wall 36 extended upward from the outer peripheral portion thereof for forming or defining a chamber 37 therein and for receiving the head 30 and the bent portions 34 of the legs 32. The upper portion 38 of the peripheral wall 36 may be folded inward toward the legs 32 and may be formed as a peripheral flange 38 for engaging onto the outer peripheral portion of the head 30 and the bent portions 34 of the legs 32 (FIGS. 4, 5), and for securing the cap 33 onto the head 30.

The head 30 and the legs 32 are preferably made of metal materials. The cap 33 may be formed or made by plastic or rubber or composite or synthetic materials, and may be engaged onto the head 30 with such as a molding or hot-melting or hot-pressing or mold injection process. The cap 33 may be formed with various kinds of colors and/or patterns thereon, and may be used to protect and to prevent the head 30 and the bent portions 34 of the legs 32 from being rusted.

In operation, as shown in FIG. 5, the legs 32 may be engaged through the paper sheets 80 and may be bent and engaged onto the paper sheets 80, for allowing the paper sheets 80 to be secured or bound together between the cap 33 and the legs 32.

Accordingly, the binding nail device in accordance with the present invention includes a protective cap for protecting the head of the binding nail device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A binding nail device comprising:
a head including an outer peripheral portion having a peripheral fence extended upward therefrom, said peripheral fence including an upper portion,
a pair of legs each including a root portion having a bent portion secured thereto and extended from said upper portion of said peripheral fence of said head, said bent portions of said legs being bent toward each other for allowing said legs to be contacted with each other, and
a cap including an outer peripheral portion having a peripheral wall extended upward therefrom for forming a chamber therein and for receiving said head and said bent portions of said legs, and said cap including a peripheral flange provided on top of said peripheral wall and extended toward said legs for engaging with said peripheral flange of said head and for securing said cap to said head.
